(19) United States
(12) Patent Application Publication
(10) Pub. No.: US 2012/0000740 A1
(43) Pub. Date: Jan. 5, 2012

(54) HYDRAULIC PRESSURE CONTROL DEVICE

(75) Inventors: Tetsuya SHIMIZU, Anjo-shi (JP); Tomoya JINNO, Nishio-shi (JP); Kenichi TSUCHIDA, Nishio-shi (JP); Naoyuki FUKAYA, Okazaki-shi (JP); Kazunori ISHIKAWA, Toyota-shi (JP)

(73) Assignee: AISIN AW CO., LTD., Anjo-shi (JP)

(21) Appl. No.: 13/158,698

(22) Filed: Jun. 13, 2011

(30) Foreign Application Priority Data
Jun. 30, 2010 (JP) 2010-149217

(51) Int. Cl. F16H 45/02; F16D 25/12

(52) U.S. Cl. 192/3.3; 192/85.63

(57) ABSTRACT

A hydraulic pressure control device including a first oil passage connected to an engagement side oil chamber defined on one side of a piston included in a clutch, an engagement pressure generating valve generating an engagement pressure supplied to the engagement side oil chamber via the first oil passage; a second oil passage connected to a back-pressure side oil chamber defined on the other side of the piston, and a clutch control pressure generating valve generating a clutch control pressure supplied to the back-pressure side oil chamber via the second oil passage and operates to lower the clutch control pressure as hydraulic pressure supplied as a feedback pressure from the back-pressure-side oil chamber side becomes higher. The hydraulic pressure control device controls a differential pressure between the engagement side oil chamber and the back-pressure side oil chamber, and the first oil passage and the second oil passage are communicated with each other via a bypass oil passage having an orifice in a midway position thereof.

### INCORPORATION BY REFERENCE

The disclosure of Japanese Patent Application No. 2010-149217 filed on Jun. 30, 2010 including the specification, drawings and abstract is incorporated herein by reference in its entirety.

### BACKGROUND OF THE INVENTION

The present invention relates to a hydraulic pressure control device that controls a differential pressure between an engagement side oil chamber defined on one side of a piston included in a clutch and a back-pressure side oil chamber defined on the other side of the piston.

### DESCRIPTION OF THE RELATED ART

As a hydraulic pressure control circuit for a vehicle torque converter equipped with a lock-up clutch whose operating state is switched by a differential pressure between an engagement side oil chamber and a release side oil chamber, there have conventionally been known hydraulic pressure control circuits that include a first oil passage communicated with the release side oil chamber, a second oil passage and a third oil passage communicated with the engagement side oil chamber in which power is transmitted between a pump impeller and a turbine runner via hydraulic oil, a high-pressure oil passage for guiding the hydraulic oil on the high-pressure side and a low-pressure oil passage for guiding the hydraulic oil on the low-pressure side, and a lock-up relay valve and a lock-up control valve that switch respective connections of the second and the third oil passages with the high-pressure and the low-pressure oil passages depending on the operating state of the lock-up clutch (for example, refer to Japanese Patent Application Publication No. JP-A-2004-340308).

In such hydraulic pressure control circuit, when the lock-up clutch is placed in the slip state, the lock-up relay valve is set in the engagement side position, and thereby a second line pressure supplied to an input port of the lock-up relay valve is supplied to the engagement side oil chamber via an engagement side port and the second oil passage. At the same time, the hydraulic oil in the engagement side oil chamber is discharged to a lubrication oil passage via the third oil passage, a control port and a bypass port of the lock-up relay valve, and a control port and a discharge port of the lock-up control valve, and discharged from the discharge port of the lock-up control valve to an oil cooler via the bypass port and a discharge port of the lock-up relay valve. In addition, the second line pressure regulated by the lock-up control valve is supplied to the release side oil chamber via the control port of the lock-up control valve, the discharge port and a release side port of the lock-up relay valve, and the first oil passage. As a result, the lock-up clutch can be placed in the slip state by making the differential pressure between the engagement side oil chamber and the release side oil chamber smaller than that in the lock-up ON state (fully engaged state). The lock-up control valve included in the hydraulic pressure control circuit is a spool valve that has a spool urged by a spring, and the lock-up control valve is provided with an oil chamber that houses the spring and receives a hydraulic pressure in the release side oil chamber of the torque converter so as to urge the spool toward a position on the slip side, an oil chamber that receives a hydraulic pressure in the engagement side oil chamber so as to urge the spool toward a position on the lock-up ON side, and an oil chamber that receives a control pressure. The lock-up control valve basically sets the differential pressure between the engagement side oil chamber and the release side oil chamber according to the control pressure when the lock-up clutch is placed in the slip state as described above.

### SUMMARY OF THE INVENTION

However, the engagement side oil chamber has a relatively large hydraulic pressure fluctuation therein, partially because a centrifugal hydraulic pressure occurs with rotation of the pump impeller and the turbine runner in the engagement side oil chamber. Therefore, if the hydraulic pressure in the engagement side oil chamber becomes higher than the second line pressure supplied from the second oil passage when the differential pressure between the engagement side oil chamber and the release side oil chamber is made small (approximately zero) in order to place the lock-up clutch in the slip state or make it stand by in the state immediately before engagement, the hydraulic pressure in the release side oil chamber is increased by a force from the engagement-side oil chamber side, and thereby the lock-up control valve that receives the hydraulic pressure in the release side oil chamber can change the position thereof to the position on the lock-up ON side. Then, if such a phenomenon occurs, the hydraulic oil in the release side oil chamber is discharged from the discharge port of the lock-up control valve with the hydraulic pressure in the engagement side oil chamber increased, thereby reducing the hydraulic pressure in the engagement side oil chamber. As a result, the lock-up clutch may be engaged rapidly, causing an engagement shock.

Therefore, it is a primary objective of the present invention to provide a hydraulic pressure control device that suppresses rapid engagement of a clutch when a differential pressure between an engagement side oil chamber defined on one side of a piston included in the clutch and a back-pressure side oil chamber defined on the other side of the piston is relatively small.

In order to achieve the primary objective described above, the hydraulic pressure control device of the present invention employs the following means.

According to a first aspect of the present invention, a hydraulic pressure control device includes: a first oil passage that is connected to an engagement side oil chamber defined on one side of a piston included in a clutch; an engagement pressure generating valve that generates an engagement pressure supplied to the engagement side oil chamber via the first oil passage; a second oil passage that is connected to a back-pressure side oil chamber defined on the other side of the piston; and a clutch control pressure generating valve that generates a clutch control pressure supplied to the back-pressure side oil chamber via the second oil passage and operates so as to make the clutch control pressure lower as a hydraulic pressure supplied as a feedback pressure from the back-pressure-side oil chamber side becomes higher. The hydraulic pressure control device controls a differential pressure between the engagement side oil chamber and the back-pressure side oil chamber. In the hydraulic pressure control device, the first oil passage and the second oil passage are communicated with each other via a bypass oil passage having an orifice in a midway position thereof.

This hydraulic pressure control device according to the first aspect is capable of controlling the differential pressure between the engagement side oil chamber and the back-pressure side oil chamber by supplying the engagement pressure generated by the engagement pressure generating valve to the engagement side oil chamber defined on the one side of the piston included in the clutch via the first oil passage, and also supplying the clutch control pressure generated by the clutch control pressure generating valve to the back-pressure side oil chamber defined on the other side of the piston via the second oil passage. Here, when the differential pressure between the engagement side oil chamber and the back-pressure side oil chamber is made small in order to place the clutch in the slip state or make it stand by in the state immediately before engagement, the hydraulic pressure in the engagement side oil chamber can be higher than the engagement pressure generated by the engagement pressure generating valve for some reason. In such a case, the hydraulic pressure in the back-pressure side oil chamber is increased by a force acting on the hydraulic oil in the back-pressure side oil chamber from the engagement-side oil chamber side via the piston, and the hydraulic pressure supplied as a feedback pressure from the back-pressure-side oil chamber side to the clutch control pressure generating valve is increased. Accordingly, the clutch control pressure generating valve operates so as to reduce the clutch control pressure, whereby the hydraulic pressure in the back-pressure side oil chamber is reduced with the hydraulic pressure in the engagement side oil chamber increased. As a result, the clutch may be engaged rapidly. In consideration of this problem, in the hydraulic pressure control device described above, the first oil passage connected to the engagement side oil chamber and the second oil passage connected to back-pressure side oil chamber are communicated with each other via the bypass oil passage having the orifice in a midway position thereof. With this structure, even if the hydraulic pressure supplied as a feedback pressure from the back-pressure-side oil chamber side to the clutch control pressure generating valve is increased by an increase in the hydraulic pressure in the engagement side oil chamber, and accordingly, even if the clutch control pressure generated by the clutch control pressure generating valve is reduced, the hydraulic oil from the engagement pressure generating valve can be allowed to flow from the first oil passage to the second oil passage so as to suppress reduction in the hydraulic pressure in the back-pressure side oil chamber. In addition, by providing the orifice in the bypass oil passage, the flow rate of the hydraulic oil from the first oil passage into the second oil passage can be set more appropriately. Therefore, with this hydraulic pressure control device, it is possible to satisfactorily suppress rapid engagement of the clutch when the differential pressure between the engagement side oil chamber and the back-pressure side oil chamber is small.

According to a second aspect of the present invention, the engagement side oil chamber may be a hydraulic power transmission chamber in which power is transmitted, via hydraulic oil, between an input-side hydraulic power transmission element and an output-side hydraulic power transmission element that are included in a hydraulic transmission apparatus. That is, according to the second aspect, even if the hydraulic pressure supplied as a feedback pressure from the back-pressure-side oil chamber side to the clutch control pressure generating valve is increased by an increase in the hydraulic pressure in the engagement side oil chamber (hydraulic power transmission chamber) due to the centrifugal hydraulic pressure occurring with rotation of the input-side hydraulic power transmission element and the output-side hydraulic power transmission element, and accordingly, even if the clutch control pressure generated by the clutch control pressure generating valve is reduced, the hydraulic oil from the engagement pressure generating valve can be allowed to flow from the first oil passage into the second oil passage so as to suppress reduction in the hydraulic pressure in the back-pressure side oil chamber, whereby rapid engagement of the clutch can be satisfactorily suppressed.

According to a third aspect of the present invention, the engagement pressure generating valve may be a modulator valve that is capable of regulating a line pressure to generate a constant modulator pressure. According to the third aspect, the fluctuation of the hydraulic pressure in the engagement side oil chamber can be suppressed, and the hydraulic pressure in the back-pressure side oil chamber can be maintained in a more stable state when the hydraulic pressure supplied as a feedback pressure from the back-pressure-side oil chamber side to the clutch control pressure generating valve is increased by an increase in the hydraulic pressure in the engagement side oil chamber, and accordingly, when the clutch control pressure is reduced.

According to a fourth aspect of the present invention, the clutch may be a lock-up clutch, and the hydraulic pressure control device may further include a linear solenoid valve that generates a lock-up control pressure, and a lock-up relay valve that establishes, when the lock-up control pressure is supplied from the linear solenoid valve, a lock-up ON state that permits the supply of the engagement pressure from the engagement pressure generating valve to the engagement side oil chamber via the first oil passage and the supply of the clutch control pressure from the clutch control pressure generating valve to the back-pressure side oil chamber via the second oil passage, and establishes, when the lock-up control pressure is not supplied from the linear solenoid valve, a lock-up OFF state that restricts the supply of the engagement pressure from the engagement pressure generating valve to the engagement side oil chamber via the first oil passage and allows a circulating pressure generated by a circulating pressure generating valve to be supplied to the back-pressure side oil chamber. According to the fourth aspect, by causing the linear solenoid valve to generate the lock-up control pressure, the lock-up relay valve can be switched from the lock-up OFF state to the lock-up ON state, and the differential pressure between the engagement side oil chamber and the back-pressure side oil chamber can be controlled.

### BRIEF DESCRIPTION OF THE DRAWINGS

FIG. 1 is a schematic diagram of an automobile 10 serving as a vehicle equipped with a power transmission device 20 containing a hydraulic pressure control device 50 according to an embodiment of the present invention;

FIG. 2 is a schematic diagram of the power transmission device 20;

FIG. 3 is an operation table indicating the relationship between each shift speed and operating states of the clutches and the brakes in an automatic transmission 40 contained in the power transmission device 20; and

FIG. 4 is a system diagram showing an essential part of the hydraulic pressure control device 50.

### DETAILED DESCRIPTION OF THE EMBODIMENTS

Next, modes for carrying out the present invention will be described by using embodiments.

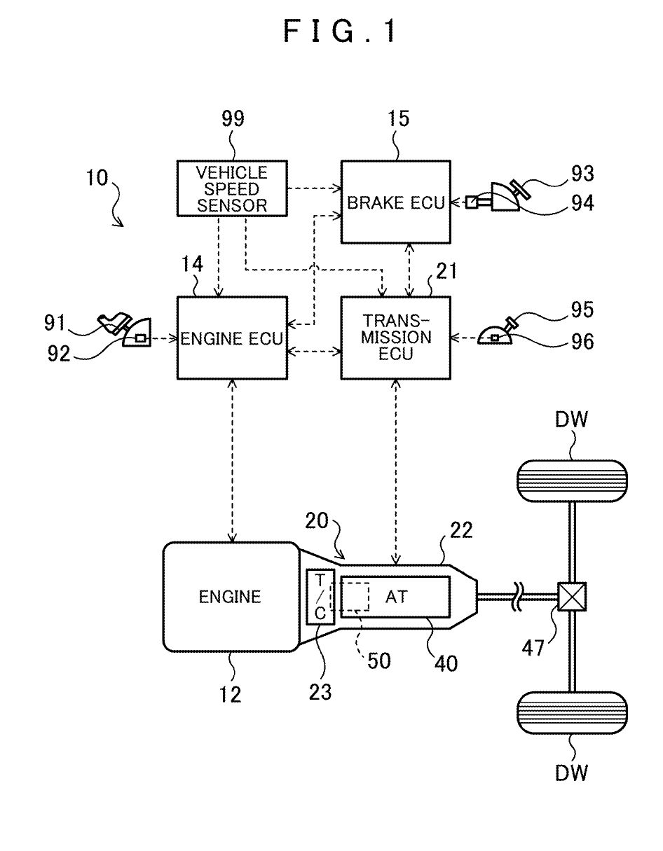

FIG. 1 is a schematic diagram of an automobile 10 serving as a vehicle equipped with a power transmission device 20 containing a hydraulic pressure control device according to an embodiment of the present invention. The automobile 10 shown in FIG. 1 has an engine 12 serving as an internal combustion engine that outputs power by explosive combustion of a mixture of air and hydrocarbon-based fuel such as gasoline or diesel oil, an engine electronic control unit (hereinafter called an “engine ECU”) 14 that controls operation of the engine 12, and a brake electronic control unit (hereinafter called a “brake ECU”) 15 that controls an electronically controlled hydraulic brake unit (not shown). The automobile 10 is also equipped with the power transmission device 20 that has a torque converter 23 serving as a hydraulic transmission apparatus, a stepped automatic transmission 40, a hydraulic pressure control device 50 that supplies and discharges hydraulic oil (working fluid) to and from the torque converter 23 and the automatic transmission 40, and a transmission electronic control unit (hereinafter called a “transmission ECU”) 21 that controls the torque converter 23, the automatic transmission 40, and the hydraulic pressure control device 50. The power transmission device 20 is connected to a crankshaft 16 of the engine 12 serving as a motor, and transmits the power from the engine 12 to left and right driving wheels DW.

As shown in FIG. 1, the engine ECU 14 is supplied with an accelerator operation amount Acc from an accelerator pedal position sensor 92 that detects a depressed amount (operation amount) of an accelerator pedal 91, a vehicle speed V from a vehicle speed sensor 99, signals from various sensors such as a crankshaft position sensor (not shown) that detects rotation of the crankshaft 16, and signals from the brake ECU 15 and the transmission ECU 21. Based on these signals, the engine ECU 14 controls an electronically controlled throttle valve, fuel injection valves, spark plugs, and the like (all not shown). The brake ECU 15 is supplied with a master cylinder pressure detected by a master cylinder pressure sensor 94 when a brake pedal 93 is depressed, the vehicle speed V from the vehicle speed sensor 99, signals from various sensors (not shown), and signals from the engine ECU 14 and transmission ECU 21. Based on these signals, the brake ECU 15 controls a brake actuator (hydraulic actuator) and the like (not shown).

The transmission ECU 21 of the power transmission device 20 is housed inside the transmission case 22. The transmission ECU 21 is supplied with a shift range SR from a shift range sensor 96 that detects an operating position of a shift lever 95 for selecting a desired shift range from a plurality of shift ranges, the vehicle speed V from the vehicle speed sensor 99, signals from various sensors (not shown), and signals from the engine ECU 14 and the brake ECU 15. Based on these signals, the transmission ECU 21 controls the torque converter 23, the automatic transmission 40, and the like. Note that each of the engine ECU 14, the brake ECU 15, and the transmission ECU 21 is structured as a microprocessor that is mainly composed of a CPU (not shown), and is provided with a ROM that stores processing programs, a RAM that temporarily stores data, input and output ports, and a communication port (all not shown) in addition to the CPU. The engine ECU 14, the brake ECU 15, and the transmission ECU 21 are connected to each other via bus lines, etc. Thus, these ECUs exchange data required for control with each other as needed.

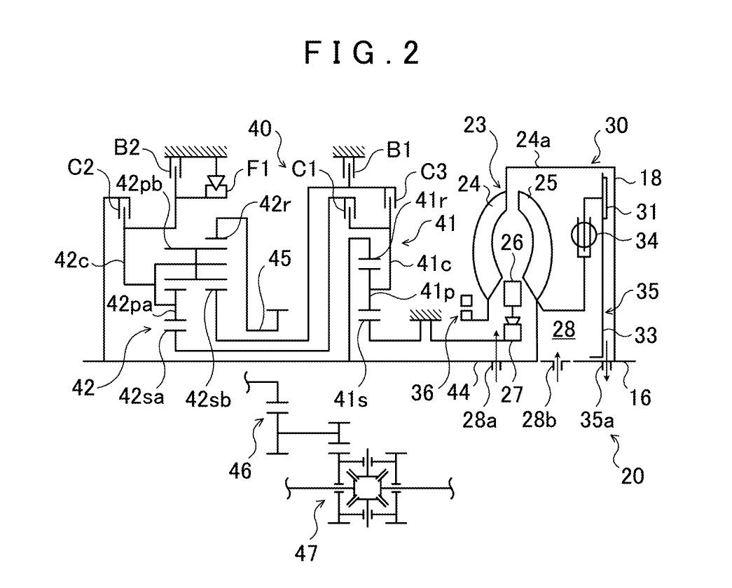

The power transmission device 20 includes the torque converter 23, an oil pump 36, the automatic transmission 40, etc. that are housed in the transmission case 22. The torque converter 23 is structured as a hydraulic torque converter with a lock-up clutch, and as shown in FIG. 2, includes a pump impeller 24 that is connected to the crankshaft 16 of the engine 12 via a front cover 18, a turbine runner 25 that is fixed to an input shaft (input member) 44 of the automatic transmission 40 via a turbine hub, a stator 26 that is arranged on the inside of the pump impeller 24 and the turbine runner 25 and straightens the flow of the hydraulic oil (ATF) from the turbine runner 25 to the pump impeller 24, and a one-way clutch 27 that limits the rotation of the stator 26 in one direction. The pump impeller 24, the turbine runner 25, and the stator 26 form a torus (annular flow passage) to circulate the hydraulic oil in a hydraulic power transmission chamber 28 that is defined by the front cover 18 and a pump shell 24a of the pump impeller 24. The hydraulic power transmission chamber 28 has a hydraulic oil inlet-outlet 28a for supplying and discharging the hydraulic oil to and from the inside thereof and a hydraulic oil outlet 28b for discharging the hydraulic oil from the inside thereof. While the engine 12 is in operation, the hydraulic oil is always fed from the hydraulic pressure control device 50 to the hydraulic oil inlet-outlet 28a, and excess hydraulic oil is discharged from the hydraulic oil outlet 28b to the outside. In the hydraulic power transmission chamber 28, power is transmitted between the pump impeller 24 serving as an input-side hydraulic power transmission element and the turbine runner 25 serving as an output-side hydraulic power transmission element via the hydraulic oil. That is, the torque converter 23 functions as a torque amplifier by an effect of the stator 26 when a rotational speed difference between the pump impeller 24 and the turbine runner 25 is large, and functions as a fluid coupling when the rotational speed difference therebetween is small.

The torque converter 23 also includes a lock-up clutch 30 that can perform a lock-up operation for connecting the pump impeller 24 with the turbine runner 25 and a release operation of the lock-up. The lock-up clutch 30 is structured as a single-plate hydraulic clutch having a lock-up piston 33 to which a sheet of friction material 31 is attached. The lock-up piston 33 is connected to the turbine runner 25 (turbine hub) with a lock-up damper 34 interposed therebetween, and arranged in a slidable manner in an axial direction inside the front cover 18. The lock-up piston 33 together with the front cover 18, etc. defines a lock-up chamber 35. The lock-up chamber 35 is opposed to the hydraulic power transmission chamber 28 with the lock-up piston 33 interposed therebetween, and has a hydraulic oil inlet 35a for introducing the hydraulic oil into the inside thereof. In the embodiment, when a predetermined lock-up condition is satisfied after the automobile 10 has started, the lock-up piston 33 is moved toward the front cover 18 by making the hydraulic pressure in the hydraulic power transmission chamber 28 higher than the hydraulic pressure in the lock-up chamber 35, and the friction material 31 is pressed to be in contact with the inner surface of the front cover 18. As a result, the pump impeller 24 (front cover 18) is connected with the turbine runner 25, thereby enabling to transmit the power from the engine 12 to an input shaft 44 of the automatic transmission 40 in a mechanical and direct manner. Note that the lock-up damper 34 absorbs a fluctuation in the torque from the pump impeller 24 side, which occurs when the lockup clutch 30 is engaged. In addition, by controlling a differential pressure between the hydraulic power transmission chamber 28 and the lock-up chamber 35, the lock-up clutch 30 can be placed in the slip state or made to stand by in the state immediately before engagement. The engagement of the lock-up clutch 30 can be released by making the hydraulic pressure in the lock-up chamber 35 higher than the hydraulic pressure in the hydraulic power transmission chamber 28.

The oil pump 36 is structured as a gear pump that is provided with a pump assembly composed of a pump body and a pump cover, and an external gear connected to the pump impeller 24 of the torque converter 23 via a hub. The oil pump 36 is connected to the hydraulic pressure control device 50. By rotating the external gear with the power from the engine 12, the hydraulic oil accumulated in an oil pan (not shown) is suctioned and discharged via a strainer (not shown) by the oil pump 36. This operation makes it possible to generate hydraulic pressures required by the torque converter 23 and the automatic transmission 40, and to feed the hydraulic oil to lubrication portions such as various bearings.

The automatic transmission 40 is structured as a six-speed stepped transmission, and as shown in FIG. 2, includes a first planetary gear mechanism 41 of a single-pinion type, a second planetary gear mechanism 42 of a Ravigneaux type, and three clutches C1, C2, and C3, two brakes B1 and B2, and a one-way clutch F1 for changing a power transmission path extending from an input side to an output side. The first planetary gear mechanism 41 of a single-pinion type has a sun gear 41s serving as an external gear that is fixed to the transmission case 22, a ring gear 41r serving as an internal gear that is concentrically arranged with the sun gear 41s and connected to the input shaft 44, a plurality of pinion gears 41p meshing with the sun gear 41s and the ring gear 41r, and a carrier 41c that holds the plurality of pinion gears 41p in a rotatable and revolvable manner. The second planetary gear mechanism 42 of a Ravigneaux type has two sun gears 42sa and 42sb serving as external gears, a ring gear 42r serving as an internal gear that is fixed to an output shaft (output member) 45 of the automatic transmission 40, a plurality of short pinion gears 42pa meshing with the sun gear 42sa, a plurality of long pinion gears 42pb meshing with the sun gear 42sb, the plurality of short pinion gears 42pa, and the ring gear 42r, and a carrier 42c that holds a mutually connected set of the plurality of short pinion gears 42pa and the plurality of long pinion gears 42pb in a rotatable and revolvable manner, and is supported by the transmission case 22 via the one-way clutch F1. An output shaft 45 of the automatic transmission 40 is connected to the driving wheels DW via a gear mechanism 46 and a differential mechanism 47.

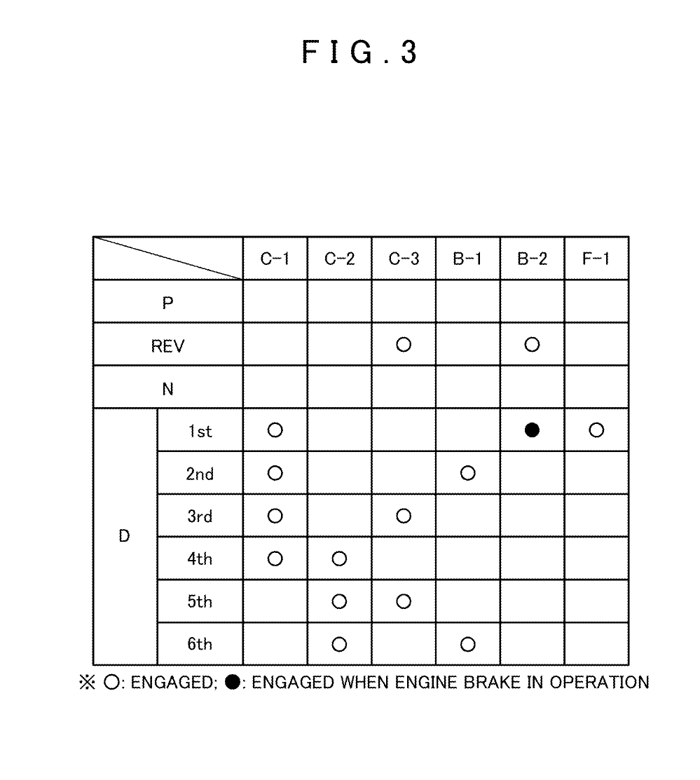

The clutch C1 is a hydraulic clutch that can engage the carrier 41c of the first planetary gear mechanism 41 with the sun gear 42sa of the second planetary gear mechanism 42, and can release the engagement. The clutch C2 is a hydraulic clutch that can engage the input shaft 44 with the carrier 42c of the second planetary gear mechanism 42, and can release the engagement. The clutch C3 is a hydraulic clutch that can engage the carrier 41c of the first planetary gear mechanism 41 with the sun gear 42sb of the second planetary gear mechanism 42, and can release the engagement. The brake B1 is a hydraulic clutch that can fix the sun gear 42sb of the second planetary gear mechanism 42 to the transmission case 22, and can release the fixation of the sun gear 42sb to the transmission case 22. The brake B2 is a hydraulic clutch that can fix the carrier 42c of the second planetary gear mechanism 42 to the transmission case 22, and can release the fixation of the carrier 42c to the transmission case 22. The clutches C1 to C3 and the brakes B1 and B2 operate in response to supply and discharge of the hydraulic oil by the hydraulic pressure control device 50. FIG. 3 shows an operation table indicating the relation ship between each shift speed of the automatic transmission 40 and operating states of the clutches C1 to C3 and the brakes B1 and B2. The automatic transmission 40 provides first to sixth forward speeds and one reverse speed by placing the clutches C1 to C3 and the brakes B1 and B2 in the states indicated in FIG. 3.

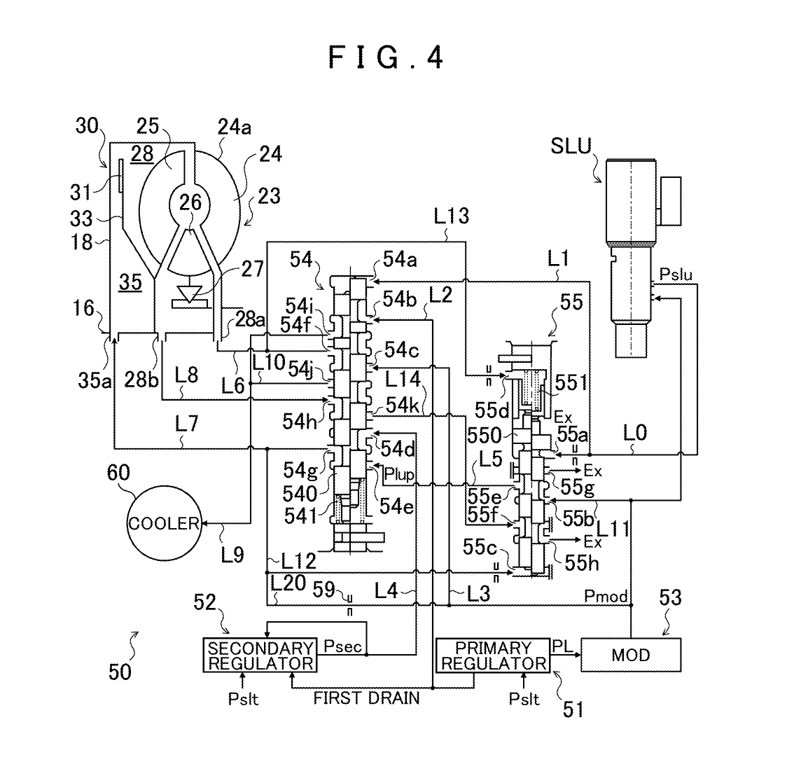

FIG. 4 is a system diagram showing an essential part of the hydraulic pressure control device 50 that supplies and discharges the hydraulic oil to and from the torque converter 23 including the lock-up clutch 30 described above, and the automatic transmission 40. The hydraulic pressure control device 50 is connected to the oil pump 36 that suctions the hydraulic oil from the oil pan (not shown) and discharges the oil by using the power from the engine 12. The hydraulic pressure control device 50 includes: a valve body (not shown) and at least one separator plate; a primary regulator valve 51 that regulates the pressure of the hydraulic oil fed from the oil pump 36 to generate a line pressure PL by being driven by a control pressure Pslt supplied from a linear solenoid valve (not shown) that regulates the pressure of the hydraulic oil fed from the oil pump 36 side (a modulator valve 53 to be described later) according to the accelerator operation amount Acc so as to output the control pressure Pslt; a secondary regulator valve (circulating pressure generating valve) 52 that generates a secondary pressure (circulating pressure) Psec by regulating the pressure of the hydraulic oil (first drain) drained from the primary regulator valve 51 so as to be lower than the line pressure PL according to the control pressure Pslt; the modulator valve (engagement pressure generating valve) 53 that regulates the line pressure PL to generate a relatively high and substantially constant modulator pressure Pmod; a manual valve that enables the hydraulic oil from the primary regulator valve to be supplied to the clutches C1 to C3 and the brakes B1 and B2, and can stop the hydraulic oil from being supplied to the clutch C1 and so on, according to the operating position of the shift lever 95; and a plurality of linear solenoid valves (all not shown) that can regulate the pressure of the hydraulic oil (line pressure PL) from the manual valve so as to supply each regulated pressure to the corresponding one of the clutches C1 to C3 and the brakes B1 and B2. All parts, such as spools and springs, of the linear solenoid valves, the primary regulator valve 51, the secondary regulator valve 52, and the modulator valve 53 are arranged in valve holes formed in the valve body.

As shown in FIG. 4, the hydraulic pressure control device 50 also includes: a lock-up solenoid valve SLU that has a linear solenoid (not shown) under energization control by the transmission ECU 21, and that generates, when the lock-up clutch 30 is maintained in the state immediately before engagement, placed in the slip state, or fully engaged, a lock-up solenoid pressure (lock-up control pressure) Pslu serving as a control pressure for generating a lock-up pressure (clutch control pressure) Plup that is obtained by regulating the modulator pressure Pmod from the modulator valve 53 and supplied to the lock-up chamber 35; a lock-up relay valve 54 that enables the hydraulic oil to be supplied to and discharged from the hydraulic power transmission chamber 28 of the torque converter 23 and performs switching of oil passages by being driven by the lock-up solenoid pressure Pslu supplied from the lock-up solenoid valve SLU; and a lock-up control valve (clutch control pressure generating valve) 55 that regulates the modulator pressure Pmod supplied from the modulator valve 53 so as to generate the lock-up pressure Plup according to the lock-up solenoid pressure Pslu supplied from the lock-up solenoid valve SLU.

The lock-up relay valve 54 is a switching valve driven by the lock-up solenoid pressure Pslu supplied from the lock-up solenoid valve SLU, and is structured as a spool valve that has a spool 540 having a plurality of lands and arranged in a slidable manner in a valve hole formed in the valve body, and a spring 541 urging the spool 540 upward in the drawing. The lock-up relay valve 54 of the embodiment includes: a signal pressure input port 54a communicated with an output port of the lock-up solenoid valve SLU via oil passages L0 and L1 formed in the valve body; a first drain input port 54b to which the hydraulic oil (first drain) drained from the primary regulator valve 51 is supplied via an oil passage L2 formed in the valve body; a modulator pressure input port 54c communicated with an output port of the modulator valve 53 via an oil passage L3 formed in the valve body; a secondary pressure input port 54d to which a secondary pressure Psec is supplied from the secondary regulator valve 52 via an oil passage L4 formed in the valve body; a lock-up pressure input port 54e to which the lock-up pressure Plup is supplied from the lock-up control valve 55 via an oil passage L5 formed in the valve body; a first output port 54f communicated with the hydraulic oil inlet-outlet 28a of the hydraulic power transmission chamber 28 of the torque converter 23 via an oil passage L6 formed in the valve body; a second output port 54g communicated with the hydraulic oil inlet 35a of the lock-up chamber 35 via an oil passage L7 formed in the valve body; a discharged oil inflow port 54h communicated with the hydraulic oil outlet 28b of the hydraulic power transmission chamber 28 via an oil passage L8 formed in the valve body; a first discharged oil outflow port 54i communicated with a hydraulic oil inlet of an oil cooler 60 via an oil passage L9 formed in the valve body; a second discharged oil outflow port 54j communicated with the hydraulic oil inlet of the oil cooler 60 via an oil passage L10 and a part of the oil passage L9 formed in the valve body; and a third discharged oil outflow port 54k. Note that all the ports of the lock-up relay valve 54 are formed in the valve body (the same applies to the lock-up control valve 55).

In the embodiment, the installed state (lock-up OFF state) of the lock-up relay valve 54 coincides with the state shown in the right half of the valve in FIG. 4. When the lock-up solenoid valve SLU does not generate the lock-up solenoid pressure Pslu, and therefore the lock-up solenoid pressure Pslu is not supplied to the signal pressure input port 54a, the lock-up relay valve 54 is maintained in the installed state, that is, in the lock-up OFF state. In the lock-up OFF state as described above, the upper end in the drawing of the spool 540 comes in contact with the valve body by being urged upward in the drawing by the spring 541. Thus, the communication between the first drain input port 54b and the first discharged oil outflow port 54i is cut off; the modulator pressure input port 54c is closed by the spool 540; the secondary pressure input port 54d is communicated with the second output port 54g; the lock-up pressure input port 54e is closed by the spool 540; the first output port 54f is communicated with the first discharged oil outflow port 54i; and the discharged oil inflow port 54h is communicated with the second discharged oil outflow port 54j.

As a result, when the lock-up solenoid valve SLU does not generate the lock-up solenoid pressure Pslu, and therefore the lock-up solenoid pressure Pslu is not supplied to the signal pressure input port 54a, that is, when the lock-up clutch 30 is disengaged, the secondary pressure (circulating pressure) Psec that is supplied from the secondary regulator valve 52 to the secondary pressure input port 54d of the lock-up relay valve 54 in the lock-up OFF state is supplied into the lock-up chamber 35 and the hydraulic power transmission chamber 28 via the second output port 54g, the oil passage L7, and the hydraulic oil inlet 35a. Then, the hydraulic oil that has flowed through the hydraulic power transmission chamber 28 flows into the oil cooler 60 via the hydraulic oil inlet-outlet 28a, the oil passage L6, the first output port 54f and the first discharged oil outflow port 54i of the lock-up relay valve 54, and the oil passage L9, and also flows into the oil cooler 60 via the hydraulic oil outlet 28b, the oil passage L8, the discharged oil inflow port 54h and the second discharged oil outflow port 54j of the lock-up relay valve 54, and the oil passages L9 and L10.

On the other hand, when the lock-up solenoid pressure Pslu is generated by the lock-up solenoid valve SLU and supplied to the signal pressure input port 54a, the spool 540 moves downward in the drawing against the urging force of the spring 541, whereby the lower end of the spool 540 comes in contact with a cap fixed to the valve body. Thus, the lock-up relay valve 54 changes the state thereof to the state shown in the left half of the valve in FIG. 4 (lock-up ON state). In the lock-up ON state as described above, the first drain input port 54b is communicated with the first discharged oil outflow port 54i; the modulator pressure input port 54c is communicated with the first output port 54f; the secondary pressure input port 54d is closed by the spool 540; the lock-up pressure input port 54e is communicated with the second output port 54g; the second discharged oil outflow port 54j is closed by the spool 540; and the discharged oil inflow port 54h is communicated with the third discharged oil outflow port 54k.

As a result, when the lock-up solenoid pressure Pslu is supplied to the signal pressure input port 54a, that is, when the lock-up clutch 30 is engaged or slip-controlled, for example, the modulator pressure Pmod that is supplied from the modulator valve 53 via the oil passage L3 to the modulator pressure input port 54c of the lock-up relay valve 54 in the lock-up ON state is supplied into the hydraulic power transmission chamber 28 via the first output port 54f, the oil passage L6, and the hydraulic oil inlet-outlet 28a. In addition, the lock-up pressure Plup that is supplied to the lock-up pressure input port 54e of the lock-up relay valve 54 via the oil passage L5 is supplied from the lock-up control valve 55 via the second output port 54g, the oil passage L7, and the hydraulic oil inlet 35a to the lock-up chamber 35 that faces the hydraulic power transmission chamber 28 with the lock-up piston 33 interposed therebetween. Therefore, in the hydraulic pressure control device 50 of the embodiment, by controlling the lock-up solenoid valve SLU to change (reduce) the lock-up pressure Plup supplied from the lock-up control valve 55, the differential pressure between the hydraulic power transmission chamber 28 and the lock-up chamber 35 can be controlled so as to place the lock-up clutch 30 in the slip state, make it stand by in the state immediately before engagement, or engage it fully. Note that parameters, such as land lengths and land-to-land distances of the spool 540, a spring constant of the spring 541, and positions of the ports, of the lock-up relay valve 54 are determined so that the switching of the oil passages as described above is performed depending on whether or not the lock-up solenoid pressure Pslu is supplied to the signal pressure input port 54a.

The lock-up control valve 55 is a pressure regulating valve driven by the lock-up solenoid pressure Pslu supplied from the lock-up solenoid valve SLU, and is structured as a spool valve that has a spool 550 having a plurality of lands and arranged in a slidable manner in a valve hole formed in the valve body, and a spring 551 urging the spool 550 downward in the drawing via a plunger. The lock-up control valve 55 of the embodiment includes: a control pressure input port 55a communicated with the output port of the lock-up solenoid valve SLU via the oil passage L0 and an orifice formed in the valve body; a modulator pressure input port 55b communicated, via an oil passage L11 formed in the valve body, with the output port of the modulator valve 53 that generates the modulator pressure Pmod serving as a source pressure of the lock-up pressure Plup; a feedback pressure input port 55c that is communicated, via an oil passage L12 and an orifice formed in the valve body, with the oil passage L7 connecting the second output port 54g of the lock-up relay valve 54 to the hydraulic oil inlet 35a of the lock-up chamber 35, and also communicated with an oil chamber defined below an end portion of the spool 550 in the drawing not in contact with the spring 551; a port 55d that is communicated, via an oil passage L13 and an orifice formed in the valve body, with the oil passage L6 connecting the first output port 54f of the lock-up relay valve 54 to the hydraulic oil inlet-outlet 28a of the hydraulic power transmission chamber 28, and also communicated with a spring chamber in which the spring 551 is arranged; an output port 55e communicated with the lock-up pressure input port 54e of the lock-up relay valve 54 via the oil passage L5; a discharged oil inflow port 55f communicated with the third discharged oil outflow port 54k of the lock-up relay valve 54 via an oil passage L14 formed in the valve body; a drain port 55g; and a discharged oil outflow port 55h. In addition, in the hydraulic pressure control device 50 of the embodiment, the oil passage L12 is communicated, via a bypass oil passage L20 having an orifice 59 in a midway position thereof, with the oil passage L3 that is communicated with the output port of the modulator valve 53, where the oil passage L12 is communicated with the oil passage L7 connecting the second output port 54g of the lock-up relay valve 54 to the hydraulic oil inlet 35a of the lock-up chamber 35, and is also communicated with the feedback pressure input port 55c of the lock-up control valve 55. Note that it is preferable, as shown in the drawing, to branch the bypass oil passage L20 from the oil passage L12 at a point on the oil passage L7 side (on the lock-up chamber 35 side) relative to the orifice that is arranged at the upstream stage of the feedback pressure input port 55c of the lock-up control valve 55 so as to suppress a rapid change in the hydraulic pressure introduced into the feedback pressure input port 55c.

In the embodiment, the lock-up solenoid pressure Pslu supplied to the first input port 55a acts on pressure receiving surfaces of two of the lands provided on the spool 540. In the embodiment, of these two lands, the land on the upper side in the drawing (on the spring 551 side) is set to have a pressure receiving surface (outside diameter) that is larger than any of the pressure receiving surface (outside diameter) of the land on the lower side in the drawing (on the opposite side of the spring 551), a pressure receiving surface of the spool 550 receiving a hydraulic pressure supplied to the feedback pressure input port 55c, and a pressure receiving surface of the spool 550 (plunger) receiving a hydraulic pressure supplied to the port 55d. Between the two lands of the spool 550 receiving the lock-up solenoid pressure Pslu, an oil chamber is defined by a difference in the pressure receiving surface areas between the two lands. This oil chamber is always communicated with the control pressure input port 55a.

The installed state (OFF state) of the lock-up control valve 55 thus structured coincides with the state shown in the right half of the valve in FIG. 4. In the installed state as described above, the lower end in the drawing of the spool 550 comes in contact with the valve body by being urged downward in the drawing by the spring 551. Thereby, the modulator pressure input port 55b is communicated with the output port 55e, and the discharged oil inflow port 55f is communicated with the discharged oil outflow port 55h. Thus, the lock-up control valve 55 is structured to be maintained in the above-described installed state when the lock-up solenoid valve SLU does not generate the lock-up solenoid pressure Pslu, and therefore the lock-up solenoid pressure Pslu is not supplied to the control pressure input port 55a.

On the other hand, when the lock-up solenoid valve SLU generates the lock-up solenoid pressure Pslu, the lock-up solenoid pressure Pslu is supplied to the control pressure input port 55a. In addition, the hydraulic pressure (feedback pressure) that is supplied from the oil passage L7 via the lock-up pressure input port 54e and the second output port 54g of the lock-up relay valve 54 and fed back from the oil passage L7 is supplied to the feedback pressure input port 55c via the oil passage L12. Moreover, a part of the hydraulic oil (the modulator pressure Pmod) supplied to the oil passage L6 via the modulator pressure input port 54c and the first output port 54f of the lock-up relay valve 54 along with the supply of the lock-up solenoid pressure Pslu to the signal pressure input port 54a is supplied to the port 55d via the oil passage L13. As a result, when the sum of a thrust force applied to the spool 550 by an action of the lock-up solenoid pressure Pslu and a thrust force applied to the spool 550 by an action of the hydraulic pressure supplied from the feedback pressure input port 55c exceeds the sum of the urging force of the spring 551 and a thrust force applied to the spool 550 by an action of the modulator pressure Pmod supplied to the port 55d, the spool 550 moves upward in the drawing (the state shown in the left half of the valve in FIG. 4: ON state), and the modulator pressure input port 55b is gradually closed as the spool 550 moves. Then, as the spool 550 moves upward in the drawing, the hydraulic oil starts to flow into an oil chamber communicated with the output port 55e only through a gap between an outer circumferential surface of a land of the spool 550 and the valve body, and increases in the amount of outflow from the oil chamber via the drain port 55g. As a result, the modulator pressure Pmod supplied to the modulator pressure input port 55b is regulated, and the lock-up pressure Plup output from the output port 55e is gradually reduced as the lock-up solenoid pressure Pslu increases. Then, the value of the lock-up pressure Plup reaches zero when the lock-up solenoid pressure Pslu reaches a predetermined value. Furthermore, when the lock-up solenoid pressure Pslu is supplied to the control pressure input port 55a, the opening amount of the discharged oil outflow port 55h is gradually reduced as the spool 550 moves upward in the drawing. Then, the discharged oil outflow port 55h is fully closed when the lock-up solenoid pressure Pslu reaches a predetermined value.

Next, description will be made of operations of the hydraulic pressure control device 50 when the differential pressure between the hydraulic power transmission chamber 28 and the lock-up chamber 35 is set to be small, such as in the case in which the lock-up clutch 30 is placed in the slip state or made to stand by in the state immediately before engagement by making the differential pressure between the hydraulic power transmission chamber 28 and the lock-up chamber 35 approximately zero.

In the case in which the lock-up clutch 30 is placed in the slip state or made to stand by in the state immediately before engagement as described above, the transmission ECU 21 controls the lock-up solenoid valve SLU to generate the lock-up solenoid pressure Pslu, and the lock-up solenoid pressure Pslu is supplied from the lock-up solenoid valve SLU to the signal pressure input port 54a of the lock-up relay valve 54. As a result, the lock-up relay valve 54 establishes the above-described lock-up ON state, in which the modulator pressure input port 54c is communicated with the first output port 54f, and accordingly a series of oil passage (first oil passage) is formed by the oil passages L3 and L6 to connect the hydraulic power transmission chamber 28 serving as an engagement side oil chamber (the hydraulic oil inlet-outlet 28a) with the output port of the modulator valve 53 that generates the modulator pressure Pmod serving as an engagement pressure. In addition, when the lock-up ON state is established by the lock-up relay valve 54, the lock-up pressure input port 54e is communicated with the second output port 54g, and accordingly a series of oil passage (second oil passage) is formed by the oil passages L5 and L7 to connect the lock-up chamber 35 (hydraulic oil inlet 35a) with the output port 55e of the lock-up control valve 55 that generates the lock-up pressure Plup serving as the clutch control pressure. Therefore, the hydraulic power transmission chamber 28 is supplied with the modulator pressure Pmod from the modulator valve 53, and the lock-up chamber 35 is supplied with the lock-up pressure Plup from the lock-up control valve 55.

Here, when the lock-up relay valve 54 has established the lock-up ON state, the hydraulic power transmission chamber 28 is supplied with the modulator pressure Pmod of a constant level. Therefore, in the case in which the differential pressure between the hydraulic power transmission chamber 28 and the lock-up chamber 35 is set to be small, the lock-up solenoid valve SLU is controlled so that the lock-up control valve 55 regulates the lock-up pressure Plup so as to be relatively approximate to the modulator pressure Pmod serving as a source pressure of the lock-up pressure Plup. Thus, the lock-up solenoid pressure Pslu generated by the lock-up solenoid valve SLU is relatively small. Besides, the hydraulic power transmission chamber 28 has a relatively large hydraulic pressure fluctuation therein, partially because a centrifugal hydraulic pressure occurs with rotation of the pump impeller 24 and the turbine runner 25 in the hydraulic power transmission chamber 28.

For this reason, if the hydraulic pressure in the hydraulic power transmission chamber 28 becomes higher than the modulator pressure Pmod supplied from the modulator valve 53 due to the centrifugal hydraulic pressure occurring with the rotation (rotational fluctuation) of the pump impeller 24, etc. when the differential pressure between the hydraulic power transmission chamber 28 and the lock-up chamber 35 is made small, a force from the hydraulic power transmission chamber 28 side acts on the hydraulic oil in the lock-up chamber 35 via the lock-up piston 33 to increase the hydraulic pressure in the lock-up chamber 35, and also to increase the hydraulic pressure supplied as a feedback pressure from the lock-up chamber 35 side to the feedback pressure input port 55c of the lock-up control valve 55 via a part of the oil passage L7 and via the oil passage L12. Thus, the lock-up control valve 55 operates so as to reduce the lock-up pressure Plup. That is, when the differential pressure between the hydraulic power transmission chamber 28 and the lock-up chamber 35 is made small, the lock-up solenoid pressure Pslu generated by the lock-up solenoid valve SLU is relatively low. In that state, when the hydraulic pressure supplied as the feedback pressure to the feedback pressure input port 55c is increased, the spool 550 of the lock-up control valve 55 moves upward in FIG. 4 against the urging force of the spring 551, etc. When the amount of hydraulic oil flowing out of the drain port 55g of the lock-up control valve 55 increases as a result of the movement, the lock-up pressure Plup generated by the lock-up control valve 55 becomes lower than an originally required value (the hydraulic oil in the lock-up chamber 35 flows out via the drain port 55g). As a result, the hydraulic pressure in the lock-up chamber 35 is reduced with the hydraulic pressure in the hydraulic power transmission chamber 28 increased. Consequently, the lock-up clutch 30 may be engaged rapidly, causing an engagement shock.

In consideration of this problem, in the hydraulic pressure control device 50 of the embodiment, the oil passage L12 is communicated, via the bypass oil passage L20 having the orifice 59 in a midway position thereof, with the oil passage L3 that is communicated with the output port of the modulator valve 53, where the oil passage L12 is communicated with the oil passage L7 connecting the second output port 54g of the lock-up relay valve 54 to the hydraulic oil inlet 35a of the lock-up chamber 35, and is also communicated with the feedback pressure input port 55c of the lock-up control valve 55. That is, the series of oil passage (first oil passage) formed by the oil passages L3 and L6 so as to connect the hydraulic power transmission chamber 28 with the output port of the modulator valve 53 when the lock-up relay valve 54 has established the lock-up ON state is communicated with the series of oil passage (second oil passage) connecting the lock-up chamber 35 with the output port 55e of the lock-up control valve 55 when the lock-up relay valve 54 has established the lock-up ON state, via the bypass oil passage L20 having the orifice 59 in a midway position thereof (and a part of the oil passage L12). Therefore, in the hydraulic pressure control device 50 of the embodiment, even if the hydraulic pressure supplied as the feedback pressure from the lock-up chamber 35 side to the lock-up control valve 55 is increased by an increase in the hydraulic pressure in the hydraulic power transmission chamber 28, and accordingly, even if the lock-up pressure Plup generated by the lock-up control valve 55 is reduced, the hydraulic oil of a relatively high pressure is allowed to flow from the oil passage L3 connected with the modulator valve 53 to the oil passage L7 connected with the lock-up chamber 35 so as to suppress flow of the hydraulic oil out of the lock-up chamber 35, whereby reduction in the hydraulic pressure in the lock-up chamber 35 can be suppressed.

As described above, in the hydraulic pressure control device 50 of the embodiment, when the lock-up ON state is established by the lock-up relay valve 54, the first oil passage is formed by the oil passages L3 and L6 so as to connect the hydraulic power transmission chamber 28 serving as the engagement side oil chamber (the hydraulic oil inlet-outlet 28a) with the output port of the modulator valve 53 that generates the modulator pressure Pmod serving as the engagement pressure, and the second oil passage is formed by the oil passages L5 and L7 so as to connect the lock-up chamber 35 (hydraulic oil inlet 35a) with the output port 55e of the lock-up control valve 55 that generates the lock-up pressure Plup serving as the clutch control pressure. In addition, the oil passage L3 included in the first oil passage is communicated with the oil passage L7 included in the second oil passage via the bypass oil passage L20 having the orifice 59 in a midway position thereof (and a part of the oil passage L12). With this structure, even if the hydraulic pressure supplied as the feedback pressure from the lock-up chamber 35 side to the lock-up control valve 55 is increased by an increase in the hydraulic pressure in the hydraulic power transmission chamber 28 in which the centrifugal hydraulic pressure occurs with rotation of the pump impeller 24 and the turbine runner 25 and thereby power is transmitted therebetween via hydraulic oil, and accordingly, even if the lock-up pressure Plup generated by the lock-up control valve 55 is reduced, the hydraulic oil from the modulator valve 53 is allowed to flow from the oil passage L3 into the oil passage L7, whereby reduction in the hydraulic pressure in the lock-up chamber 35 can be suppressed. In addition, by providing the orifice 59 in the bypass oil passage L20, the flow rate of the hydraulic oil from the oil passage L3 into the oil passage L7 can be set more appropriately. Therefore, with the hydraulic pressure control device 50 of the embodiment, it is possible to satisfactorily suppress rapid engagement of the lock-up clutch 30 when the differential pressure between the hydraulic power transmission chamber 28 and the lock-up chamber 35 is small.

Moreover, in the hydraulic pressure control device 50 of the embodiment, when the lock-up ON state is established by the lock-up relay valve 54, the modulator pressure Pmod from the modulator valve 53 that can regulate the line pressure PL to generate the modulator pressure Pmod of the constant level is supplied as the engagement pressure to the hydraulic power transmission chamber 28 via the oil passages L3 and L6, and the hydraulic oil from the modulator valve 53 flows from the oil passage L3 into the oil passage L7. As a result, the fluctuation of the hydraulic pressure in the hydraulic power transmission chamber 28 can be suppressed, and the hydraulic pressure in the lock-up chamber 35 can be maintained in a more stable state when the hydraulic pressure supplied as the feedback pressure from the lock-up chamber 35 side to the lock-up control valve 55 is increased by an increase in the hydraulic pressure in the hydraulic power transmission chamber 28, and accordingly, when the lock-up pressure Plup is reduced.

Furthermore, the hydraulic pressure control device 50 of the embodiment includes the lock-up solenoid valve SLU serving as a linear solenoid valve that generates the lock-up solenoid pressure Pslu serving as a lock-up control pressure, and also includes the lock-up relay valve 54. The lock-up relay valve 54 establishes, when being supplied with the lock-up solenoid pressure Pslu from the lock-up solenoid valve SLU, the lock-up ON state that allows the modulator pressure Pmod to be supplied from the modulator valve 53 to the hydraulic power transmission chamber 28 via the oil passages L3 and L6 (first oil passage) and the lock-up pressure Plup to be supplied from the lock-up control valve 55 to the lock-up chamber 35 via the oil passages L5 and L7 (second oil passage), whereas the lock-up relay valve 54 establishes, when not being supplied with the lock-up solenoid pressure Pslu from the lock-up solenoid valve SLU, the lock-up OFF state that restricts the modulator pressure Pmod from being supplied from the modulator valve 53 to the hydraulic power transmission chamber 28 via the oil passages L3 and L6 (first oil passage) and allows the secondary pressure Psec generated by the secondary regulator valve 52 to be supplied to the lock-up chamber 35. Accordingly, the hydraulic pressure control device 50 can switch the lock-up relay valve 54 from the lock-up OFF state to the lock-up ON state, and control the differential pressure between the hydraulic power transmission chamber 28 and the lock-up chamber 35, by causing the lock-up solenoid valve SLU to generate the lock-up solenoid pressure Pslu.

Note that each of the merging portion between the first oil passage composed of the oil passages L3 and L6 and the bypass oil passage L20 (oil passage L12) and the merging portion between the second oil passage composed of the oil passages L5 and L7 and the bypass oil passage L20 can be located at any position. For example, the bypass oil passage L20 may be communicated directly with the oil passage L7 instead of being communicated with the oil passage L12. In addition, the torque converter 23 to be supplied with the hydraulic pressure from the hydraulic pressure control device 50 may have two hydraulic oil inlet-outlets (while omitting the hydraulic oil outlet 28b in the embodiment). Moreover, the present invention may be applied, for example, to a start clutch arranged between the engine and the transmission instead of being applied to the torque converter. The power transmission device 20 of the embodiment may include a fluid coupling that does not provide a torque amplifying effect instead of including the torque converter 23 that provides the torque amplifying effect. Furthermore, the hydraulic pressure control device 50 and the torque converter 23 that includes the lock-up clutch 30 may be combined with a continuously variable transmission (CVT) other than an automatic transmission.

Here, description will be made of correspondences between the main elements of the embodiment and the main elements of the present invention described in the section “Disclosure of the Invention”. That is, in the above-described embodiment, the oil passages L3 and L6 correspond to the “first oil passage”, where the oil passages L3 and L6 are connected to the hydraulic power transmission chamber 28 serving as the engagement side oil chamber defined on one side of the lock-up piston 33 included in the lock-up clutch 30; the modulator valve 53 corresponds to the “engagement pressure generating valve”, where the modulator valve 53 generates the modulator pressure Pmod serving as the engagement pressure supplied to the hydraulic power transmission chamber 28 via the oil passages L3 and L6; the oil passages L5 and L7 correspond to the “second oil passage”, where the oil passages L5 and L7 are connected to the lock-up chamber 35 serving as the back-pressure side oil chamber defined on the other side of the lock-up piston 33; the lock-up control valve 55 corresponds to the “clutch control pressure generating valve”, where the lock-up control valve 55 generates the lock-up pressure Plup serving as the clutch control pressure supplied to the lock-up chamber 35 via the oil passages L5 and L7 according to the lock-up solenoid pressure Pslu serving as the lock-up control pressure, and operates so as to make the lock-up pressure Plup lower as the hydraulic pressure supplied as the feedback pressure from the lock-up chamber 35 side becomes higher; the orifice 59 corresponds to the “orifice”; and the bypass oil passage L20 and a part of the oil passage L12 correspond to the “bypass oil passage”. In addition, the lock-up solenoid valve SLU generating the lock-up solenoid pressure Pslu corresponds to the “linear solenoid valve”, and the lock-up relay valve 54 corresponds to a “lock-up relay valve”, where the lock-up relay valve 54 establishes, when being supplied with the lock-up solenoid pressure Pslu from the lock-up solenoid valve SLU, the lock-up ON state that allows the modulator pressure Pmod to be supplied from the modulator valve 53 to the hydraulic power transmission chamber 28 via the oil passages L3 and L6 and the lock-up pressure Plup to be supplied from the lock-up control valve 55 to the lock-up chamber 35 via the oil passages L5 and L7, while establishing, when not being supplied with the lock-up solenoid pressure Pslu from the lock-up solenoid valve SLU, the lock-up OFF state that restricts the modulator pressure Pmod from being supplied from the modulator valve 53 to the hydraulic power transmission chamber 28 via the oil passages L3 and L6 and allows the secondary pressure Psec generated by the secondary regulator valve 52 to be supplied to the lock-up chamber 35.

However, because the embodiment is an example for specifically explaining the modes for carrying out the invention described in “Disclosure of the Invention”, the correspondences between the main elements of the embodiment and the main elements of the present invention described in “Disclosure of the Invention” do not limit the elements of the present invention described in “Disclosure of the Invention”. In other words, the embodiment is merely a specific example of the present invention described in “Disclosure of the Invention”, and the interpretation of the present invention described in “Disclosure of the Invention” should be made based on the description therein.

The modes for carrying out the invention have been described above by using an embodiment. However, the present invention is not limited to the embodiment described above in any manner, and can obviously be modified in various ways within the scope not departing from the gist of the present invention.

The present invention can be used in the manufacturing industry of hydraulic pressure control devices.

What is claimed is:

1. A hydraulic pressure control device comprising:
a first oil passage that is connected to an engagement side oil chamber defined on one side of a piston included in a clutch;
an engagement pressure generating valve that generates an engagement pressure supplied to the engagement side oil chamber via the first oil passage;
a second oil passage that is connected to a back-pressure side oil chamber defined on the other side of the piston; and
a clutch control pressure generating valve that generates a clutch control pressure supplied to the back-pressure side oil chamber via the second oil passage and operates so as to make the clutch control pressure lower as a hydraulic pressure supplied as a feedback pressure from the back-pressure-side oil chamber side becomes higher, wherein
the hydraulic pressure control device controls a differential pressure between the engagement side oil chamber and the back-pressure side oil chamber, and
the first oil passage and the second oil passage are communicated with each other via a bypass oil passage having an orifice in a midway position thereof

2. The hydraulic pressure control device according to claim 1, wherein
the engagement side oil chamber is a hydraulic power transmission chamber in which power is transmitted, via hydraulic oil, between an input-side hydraulic power transmission element and an output-side hydraulic power transmission element that are included in a hydraulic transmission apparatus.

3. The hydraulic pressure control device according to claim 1, wherein
the engagement pressure generating valve is a modulator valve that is capable of regulating a line pressure to generate a constant modulator pressure.

4. The hydraulic pressure control device according to any one of claims 1 to 3, wherein
the clutch is a lock-up clutch; and
the hydraulic pressure control device further comprises: a linear solenoid valve that generates a lock-up control pressure; and a lock-up relay valve that establishes, when the lock-up control pressure is supplied from the linear solenoid valve, a lock-up ON state that permits the supply of the engagement pressure from the engagement pressure generating valve to the engagement side oil chamber via the first oil passage and the supply of the clutch control pressure from the clutch control pressure generating valve to the back-pressure side oil chamber via the second oil passage, and establishes, when the lock-up control pressure is not supplied from the linear solenoid valve, a lock-up OFF state that restricts the supply of the engagement pressure from the engagement pressure generating valve to the engagement side oil chamber via the first oil passage and allows a circulating pressure generated by a circulating pressure generating valve to be supplied to the back-pressure side oil chamber.
